(19) United States
(12) Patent Application Publication
(10) Pub. No.: US 2010/0161807 A1
(43) Pub. Date: Jun. 24, 2010

(54) METHOD AND APPARATUS FOR ADDRESS BOOK UPDATES

(75) Inventor: Miraj Mostafa, Tampere (FI)

Correspondence Address: Nokia, Inc., 6021 Connection Drive, MS 2-5-520, Irving, TX, 75039, US

(73) Assignee: Nokia Corporation, Espoo (FI)

(21) Appl. No.: 12/507,132

(22) Filed: Jul. 22, 2009

Related U.S. Application Data
(60) Provisional application No. 61/083,130, filed on Jul. 23, 2008.

(51) Int. Cl. G06F 17/30; G06F 15/16

(52) U.S. Cl. 709/227; 707/618; 707/E17.005; 707/E17.032

(57) ABSTRACT

A method comprises receiving an indication of a list of contacts in an address book to receive an automatic update; submitting a subscription request for the contacts; receiving updates for contact information for the subscribed contacts; and synchronizing the updates with the address book, wherein the synchronizing includes synchronizing only the updated contacts.

### RELATED APPLICATIONS

This application claims priority to U.S. Provisional Application No. 61/083,130 which was filed on Jul. 23, 2009.

### FIELD OF INVENTION

This invention relates to electronic address books. In particular, the present invention relates to updating of such address books.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Address books are referred to in the industry by various names, such as phonebook, contacts, etc. A Network Address Book (NAB) is an address book stored in a network. The Open Mobile Alliance (OMA) is in the process of standardizing an NAB in terms of a Converged Address Book (CAB).

With such standardization, CAB may define a network repository for the own contact information of a user, referred to as a Personal Contact Card (PCC). A user is expected to maintain and update his/her PCC in the network. The repository of the PCC's of various users is referred to herein as a PCC Server.

It is a common practice to update address book. Conventionally, an address book is updated manually by the owner of the address book, requiring user interaction and effort for each update, resulting in poor user experience. Thus, it is possible that the address book is not always current. Further, as it is done manually based on availability of the update through different indirect approaches, the contact information of a user may remain out of date for a long time. Further, it is possible that the manually updated contact information is not correctly entered and may contain typographical errors due to human mistake.

### SUMMARY OF THE INVENTION

In one aspect of the invention, a method comprises receiving an indication of a list of contacts in an address book to receive an automatic update; submitting a subscription request for the contacts; receiving updates for contact information for the subscribed contacts; and synchronizing the updates with the address book, wherein the synchronizing includes synchronizing only the updated contacts.

In one embodiment, the receiving an indication includes receiving a filtering document. In another embodiment, the receiving an indication includes receiving a list of contacts. The list of contacts may be in the form of an XML document. In one embodiment, the submission of a subscription request includes using a session initiation protocol subscription mechanism.

In another aspect, an apparatus comprises a processor and a memory unit communicatively connected to the processor. The memory unit includes computer code for receiving an indication of a list of contacts in an address book to receive an automatic update; computer code for submitting a subscription request for the contacts; computer code for receiving updates for contact information for the subscribed contacts; and computer code for synchronizing the updates with the address book, wherein the synchronizing includes synchronizing only the updated contacts.

In another aspect, the invention relates to a computer program product embodied on a computer-readable medium. The computer program product comprises computer code for receiving an indication of a list of contacts in an address book to receive an automatic update; computer code for submitting a subscription request for the contacts; computer code for receiving updates for contact information for the subscribed contacts; and computer code for synchronizing the updates with the address book, wherein the synchronizing includes synchronizing only the updated contacts.

These and other advantages and features of various embodiments of the present invention, together with the organization and manner of operation thereof, will become apparent from the following detailed description when taken in conjunction with the accompanying drawings.

### BRIEF DESCRIPTION OF THE DRAWINGS

Example embodiments of the invention are described by referring to the attached drawings, in which:

FIG. 1 is a schematic illustration of an exemplary architecture and flow of an address book update system according to an embodiment of the present invention;

FIG. 2 is a flowchart illustrating an exemplary address book update process in accordance with embodiments of the present invention;

FIG. 3 is a schematic illustration of an exemplary architecture of an address book update system according to an embodiment of the present invention;

FIG. 4 is a schematic illustration of an exemplary overall architecture of an address book update system according to an embodiment of the present invention;

FIG. 5 is an overview diagram of a system within which various embodiments of the present invention may be implemented;

FIG. 6 illustrates a perspective view of an example electronic device which may be utilized in accordance with the various embodiments of the present invention; and

FIG. 7 is a schematic representation of the circuitry which may be included in the electronic device of FIG. 6.

### DETAILED DESCRIPTION OF THE VARIOUS EMBODIMENTS

In the following description, for purposes of explanation and not limitation, details and descriptions are set forth in order to provide a thorough understanding of the present invention. However, it will be apparent to those skilled in the art that the present invention may be practiced in other embodiments that depart from these details and descriptions.

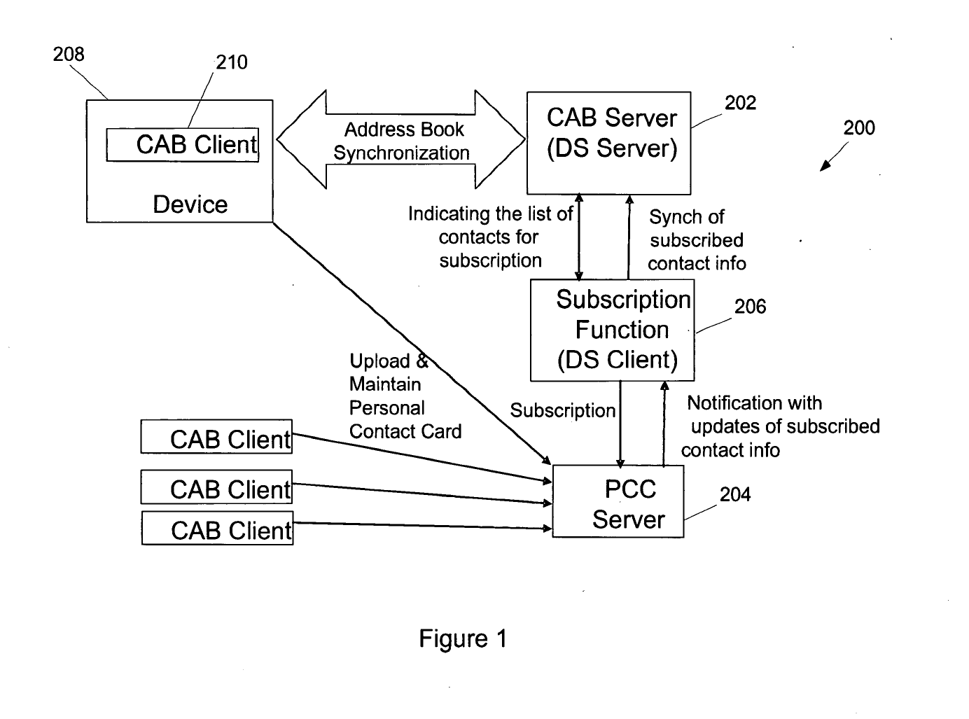

Embodiments of the present invention provide an efficient and reliable address book update system, apparatus and method. Referring now to FIG. 1, an exemplary architecture and flow of an address book update system according to an embodiment of the present invention is schematically illustrated. The address book update system 200 includes a CAB server 202 configured to function as a server for the address book of a user. In one embodiment, as illustrated in parentheses in FIG. 1, the CAB server is an OMA data synchronization (DS) server. A CAB client 210 is provided in a user device 208 to maintain the address book of the user in the CAB server 202. In the illustrated embodiment, the CAB client also includes the functionality of a DS client. As exemplarily illustrated in FIG. 1, the address book update system 200 may be configured to accommodate any number of CAB clients.

An interface may be provided between the CAB client 210 and the CAB server 202. This interface may be configured to support the data synchronization between the CAB client 210 and the CAB server 202 and may support the following functions:

1) data synchronization protocol of the CAB;

2) CAB management function such as add, delete, update of the CAB; and

3) mutual authentication with the CAB client 210.

A Personal Contact Card (PCC) server 204 is provided to function as a repository of the PCC's of various users.

In accordance with embodiments of the present invention, a subscription function (SF) 206 is provided between the CAB server (or DS server) 202 and the PCC server 204. In the illustrated embodiment, the SF 206 is configured to function as a DS client. In accordance with embodiments of the present invention, the DS client and the SF may belong to the same logical entity. Thus, the DS client may be coupled with the SF. Further, while the DS client and the SF are illustrated as a logical entity in FIG. 1, in various embodiments, the DS client and the SF may be implemented as separated physical entities.

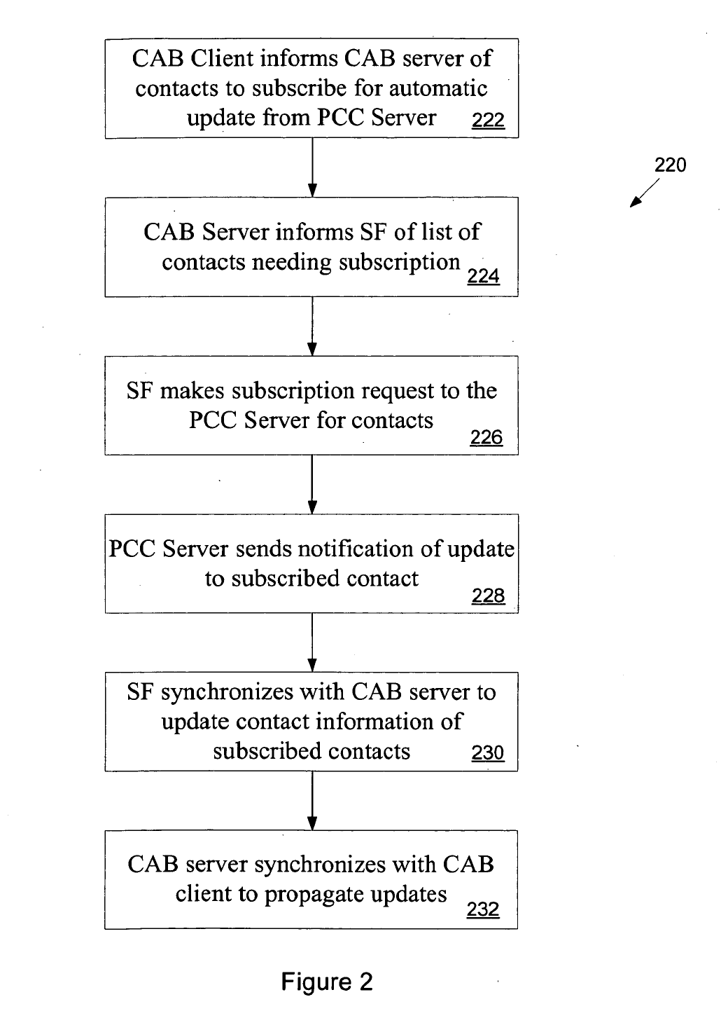

In accordance with embodiments of the present invention, synchronization of the address book is performed between the CAB client 210 and the CAB server 202. The synchronization or update process will be described with reference to FIGS. 1 and 2, in which FIG. 2 is a flowchart illustrating an exemplary address book update process in accordance with embodiments of the present invention. In the exemplary process 220, the CAB client 210 informs the CAB server 202 about the contacts for whom the CAB server 202 should subscribe for automatic update from the PCC server 204 (block 222 of FIG. 2). As used herein, a “contact” may refer to a person or an entity having contact information. In various embodiments of the present invention, this is achieved by providing a new flag, attribute, parameter or other feature within e.g. vCard, which is widely used as the data format of address book. The value of the flag, attribute, parameter or other feature may indicate whether the corresponding contact should be subscribed.

The CAB server 202 then informs the SF 206 (or the DS client within the SF 206) about the list of contacts that need subscription (block 224 of FIG. 2). In one embodiment, filtering of OMA DS is implemented so that the CAB server (or DS server) creates a filtering document including the contact entries requiring subscription. Upon creating such filtering document, the CAB server may notify the DS client for synchronization based on the solution defined by the OMA DS.

Upon receiving the notification, the DS client (which may be coupled with the SF) starts synchronizing with the CAB server and receives the contact entries for subscription. Then, the DS client hands over the list of contact entries to the SF, and the SF makes subscription request for the entries to the PCC server 204 (block 226 of FIG. 2). In this regard, the SF may use the session initiation protocol (SIP) subscription mechanism. In one embodiment, the PCC server is based on OMA XDM.

In accordance with embodiments of the present invention, upon receiving the subscription request, the PCC server 204 follows the SIP subscription mechanism and sends notification for each update of the subscribed contact entries (block 228 of FIG. 2). The SF may then hand over the updated contact information to DS client, and the DS client may synchronize with the CAB server 202 (block 230 of FIG. 2) to update the contact information of the subscribed contacts with the address book in CAB Server. The synchronization may be based on OMA DS. The updates are propagated to CAB client later, when the address book is synchronized between the CAB client and CAB server, again potentially based on OMA DS. At block 232 of FIG. 2, the CAB server synchronizes with the CAB client. In this regard, updates of the contact information are propagated to the local address book in the device.

Thus, in accordance with embodiments of the present invention, only the contact information of the updated contact entry is synchronized. In this regard, the CAB server gets automatic updates of the contact information for the subscribed contact entries, and the updates are propagated to the CAB client 210 in the user device 208 through synchronization so that the local copy of the address book in a device also has the updates of the contact information.

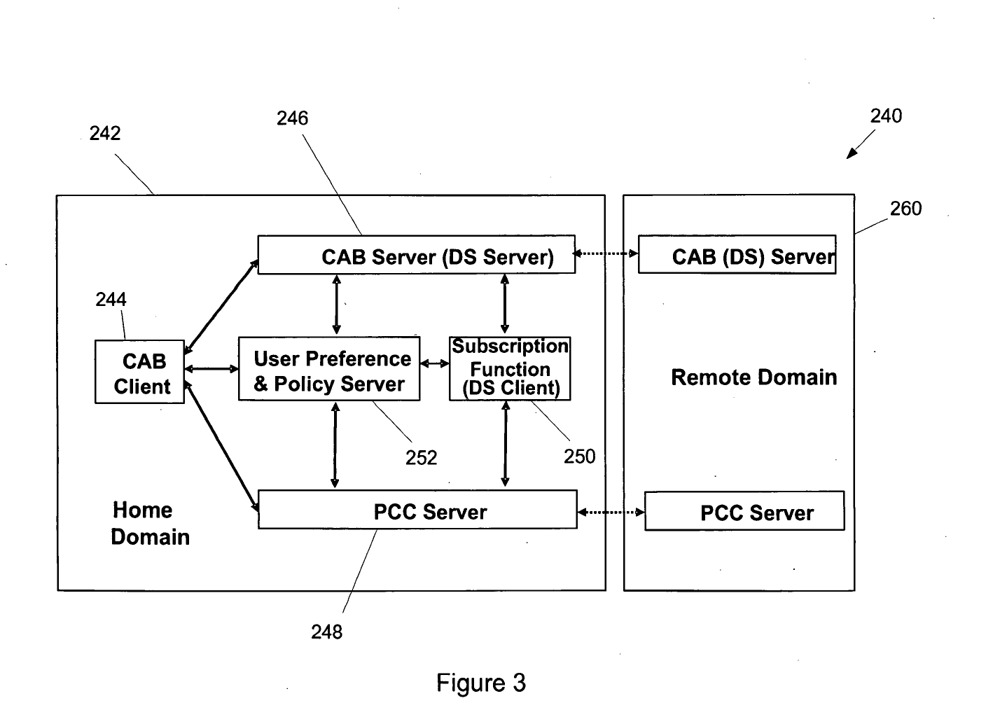

Referring now to FIG. 3, another exemplary embodiment of an address book update system is illustrated. In the illustrated system 240, a CAB client 244, a CAB server 246, a PCC server 248, and an SF with a DS client 250 are provided in a home domain 242, similar to the embodiment described above with reference to FIG. 1. In the embodiment of FIG. 3, the system further includes a User Preference & Policy server 252 configured to communicate with each of the other components 244, 246, 248 and 250. The User Preference & Policy server 252 is configured to store authorization rules for subscription and search. Thus, in addition to maintaining Personal Contact Card, a user may also maintain authorization rules for subscribing and searching his/her Personal Contact Card. Further, the User Preference & Policy server 252 may also store user preferences, such as the contact information that the SF should subscribe for each contact. Thus, in one embodiment, upon receiving the list of contacts that the SF needs to subscribe, the SF retrieves the list of desired contact information from the User Preference & Policy server 252 and subscribes only for the desired information to the PCC Server 248.

In the embodiment illustrated in FIG. 3, the system 240 further includes a remote domain. When the SF makes a subscription request, it is possible that all of the subscribed users do not belong to the home domain. For users belonging to one or more remote domains, the SF may forward the subscription request to the PCC server of the remote domain. The remote domain may also facilitate searching. In this regard, search requests by a user may be forwarded to one or more remote domains.

In one embodiment, the CAB server is configured to subscribe for all the contact entries of the address book. Thus, the CAB client is not required to use any additional flag, parameter, or attribute of a vCard to indicate if a contact needs subscription. In this regard, the filtering document created by the CAB server includes all the contacts of the address book. In this case, the SF subscribes for all the contacts of the address book of a user, and only gets updates of the contacts of a user who made his/her Personal Contact Card available in the PCC server and allowed the subscribing user for subscription in authorization rules.

In another embodiment, a list of contacts (whose contact information to be subscribed for automatic update) is maintained in the User Preference & Policy server. The list may be maintained as an XML document. In the regard, the User Preference & Policy server may be an XML document management (XDM) server. In this embodiment, the SF may retrieve the XML document form the User Preference & Policy server.

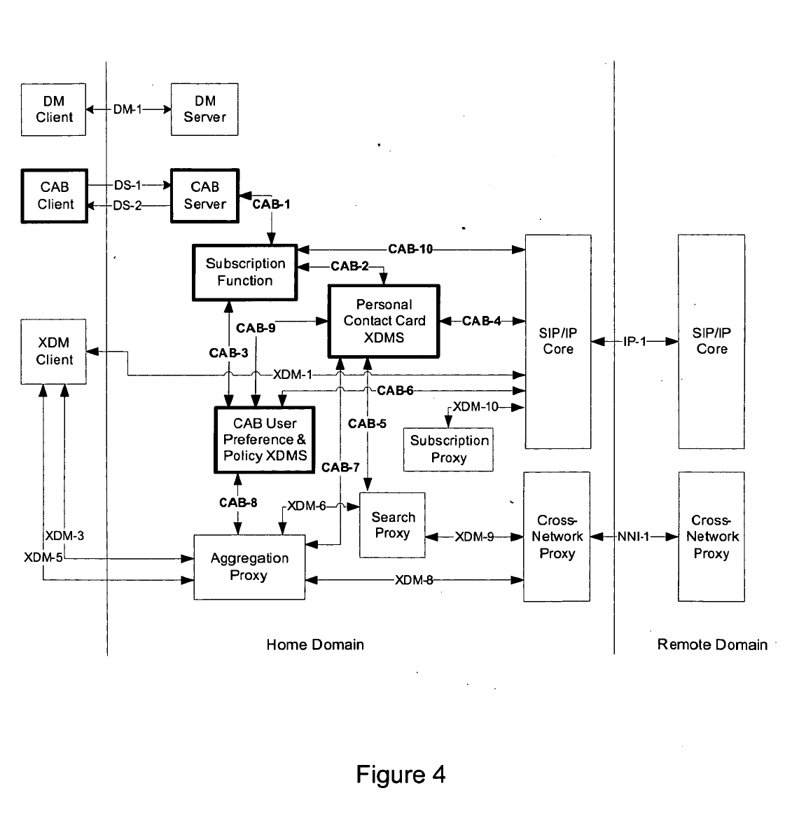

Referring now to FIG. 4, an overall detailed architecture of an address book update system is schematically illustrated. The embodiment illustrated in FIG. 4 includes many of the components described above with reference to FIGS. 1-3 and also includes additional components. As will be appreciated by those skilled in the art, various embodiments of the present invention may include more, less or different components than those illustrated in the embodiments described herein. All such embodiments are considered within the scope of the present invention.

In accordance with embodiments of the present invention, the CAB client may be a client entity that provides access to the Converged Address Book (CAB) stored in the network. The CAB client may support performing mutual authentication with the CAB server and synchronizing the CAB with the CAB server, including adding, deleting or modifying contacts.

In accordance with embodiments of the present invention, the CAB server may be a server entity that acts as the contact point for CAB stored in the network. The CAB server may support the following functions:

performs mutual authentication with the CAB Clients;

stores the CAB;

synchronizes with CAB client the CAB data resulting from one or more actions performed on the CAB data, by the CAB client;

allows management (e.g., adding, deleting or modifying) of the CAB;

provides the list of users to Subscription Function (SF) for contact subscription; and

synchronizes the CAB with the data from contact subscription available in the SF.

In accordance with embodiments of the present invention, the Subscription Function (SF) may be the network entity that subscribes, on behalf of a CAB user, for Personal Contact Cards (PCC) of other specified CAB users. The SF may support the following functions:

receives from the CAB server a list of CAB users, whose PCC to subscribe;

receives from the CAB User Preference & Policy XDMS the specified contact card properties/attributes for subscription;

performs contact subscriptions on behalf of a CAB user, to the contacts selected by the CAB user; and

synchronizes the resulting data from contact subscription with the CAB user's CAB in the CAB server.

In accordance with embodiments of the present invention, the Personal Contact Card XDMS may be a server entity that supports the following functions:

stores and provides management operations (e.g., add, update, delete, create) for PCC XML documents;

provides up-to-date PCC XML document

notifies subscribers of changes to the PCC XML documents;

provides aggregation of notifications of changes to multiple XML documents;

receives search requests for PCC data, and returns the data that the requestor is authorized to receive;

receives subscription request for PCC XML documents;

retrieves authorization rules from CAB User Preference & Policy XDMS; and

performs authorization of incoming SIP and XCAP requests.

In accordance with embodiments of the present invention, the CAB User Preference & Policy XDMS may be a server entity that supports the following functions:

stores and provides management operations for user preferences (e.g., list of properties/attributes of a contact card that a CAB user wants to subscribe) and policy (e.g., authorization rules that defines which CAB User gets what part of own PCC in response to contact subscription) XML documents;

receives subscription request for notification of changes in XML document and notifies subscribers of changes in XML documents;

provides aggregation of notifications of changes to multiple XML documents;

makes user preferences available to the SF;

makes authorization rules available to PCC XDMS; and

performs authorization of incoming SIP and XCAP requests

In accordance with embodiments of the present invention, the Device Management (DM) client may perform the following function in support of an XDMC residing in a user device:

receives the initial configuration parameters and the updated parameters needed for XDM service sent by the DM server.

In accordance with embodiments of the present invention, the DM server may perform the following function:

initializes and updates the configuration parameters necessary for the XDMC.

In accordance with embodiments of the present invention, the CAB-1 reference point may support the communications between CAB server and the SF. The CAB-1 reference point may support the following functions:

publish a list of CAB users to be subscribed by the SF; and

synchronization between the changes to the PCC of the subscribed CAB users and the CAB of the subscribing CAB user.

In accordance with embodiments of the present invention, the CAB-2 reference point may support the communications between the SF and PCC XDMS. The protocol for the CAB-2 reference point may be XCAP. The CAB-2 reference point may support the following function:

retrieval of PCCs form the PCC XDMS.

In accordance with embodiments of the present invention, the CAB-3 reference point may support the communications between the SF and CAB User Preference and Policy XDMS. The protocol for the CAB-3 reference point may be XCAP. The CAB-3 reference point may support the following function:

retrieval of user preferences from the CAB User Preference & Policy XDMS.

In accordance with embodiments of the present invention, the CAB-4 reference point may support the communications between PCC XDMS and SIP/IP Core. The protocol for the CAB-4 reference point may be SIP. The CAB-4 reference point may support the following functions:

subscription to the modifications of PCC XML documents;

notification of the modifications of PCC XML documents.

In accordance with embodiments of the present invention, the CAB-5 reference point may support the communications between PCC XDMS and Search Proxy. The protocol for the CAB-5 reference point may be Limited XQuery over HTTP [XDM_Core]. The CAB-5 reference point may support the following function:

searching data from Personal Contact Card XML documents stored in PCC XDMS.

In accordance with embodiments of the present invention, the CAB-6 reference point may support the communications between CAB User Preference & Policy XDMS and SIP/IP Core. The protocol for the CAB-6 reference point may be SIP. The CAB-6 reference point may support the following functions:

subscription to the modifications of user preference & policy XML documents;

notification of the modifications of user preference & policy XML documents.

In accordance with embodiments of the present invention, the CAB-7 reference point may support the communications between PCC XDMS and Aggregation Proxy. The protocol for the CAB-7 reference point may be XCAP. The CAB-7 reference point may support the following function:

XML document management (e.g. create, modify, retrieve, delete) of PCC XML documents in the PCC XDMS.

In accordance with embodiments of the present invention, the CAB-8 reference point may support the communications between CAB User Preference & Policy XDMS and Aggregation Proxy. The protocol for the CAB-8 reference point may be XCAP. The CAB-8 reference point supports the following function:

XML document management (e.g., create, modify, retrieve, delete) of user preference & policy XML documents in the CAB User Preference & Policy XDMS.

In accordance with embodiments of the present invention, the CAB-9 reference point may support communication between PCC XDMS and CAB User Preference & Policy XDMS. The protocol for the CAB-9 reference point may be XCAP. The CAB-9 reference point supports the following function:

retrieval of user policy from the CAB User Preference & Policy XDMS.

In accordance with embodiments of the present invention, the CAB-10 reference point may support the communications between the SF and SIP/IP Core. The protocol for the CAB-10 reference point may be SIP. The CAB-10 reference point may support the following functions:

subscription to the modifications of PCC XML documents;

notification of the modifications of PCC XML documents.

Thus, embodiments of the present invention solve the update needs for a CAB. In accordance with embodiments of the present invention, the subscription function is decoupled from the CAB server so that the existing implementations of the DS server can be re-used as the CAB server.

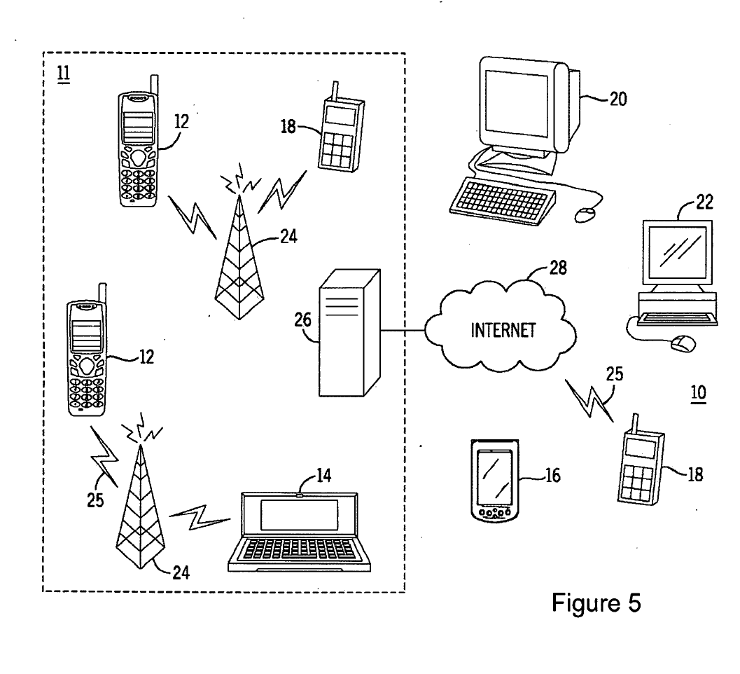

FIG. 5 shows a system 10 in which various embodiments of the present invention can be utilized, comprising multiple communication devices that can communicate through one or more networks. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 5 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The example communication devices of the system 10 may include, but are not limited to, an electronic device 12 in the form of a mobile telephone, a combination personal digital assistant (PDA) and mobile telephone 14, a PDA 16, an integrated messaging device (IMD) 18, a desktop computer 20, a notebook computer 22, etc. The communication devices may be stationary or mobile as when carried by an individual who is moving. The communication devices may also be located in a mode of transportation including, but not limited to, an automobile, a truck, a taxi, a bus, a train, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device involved in implementing various embodiments of the present invention may communicate using various media including, but not limited to, radio, infrared, laser, cable connection, and the like.

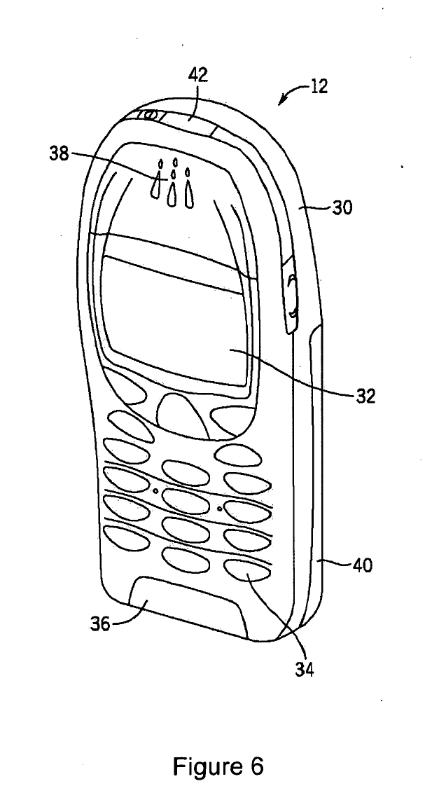

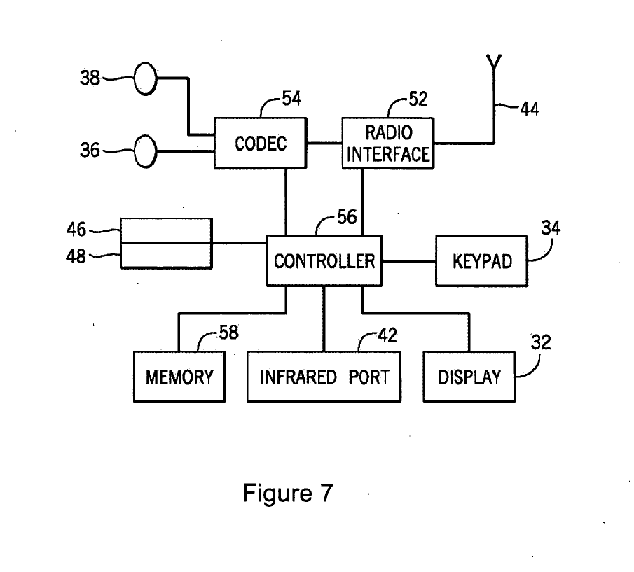

FIGS. 6 and 7 show one representative electronic device 28 which may be used as a network node in accordance to the various embodiments of the present invention. It should be understood, however, that the scope of the present invention is not intended to be limited to one particular type of device. The electronic device 28 of FIGS. 6 and 7 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment, a card reader 48, radio interface circuitry 52, codec circuitry 54, a controller 56 and a memory 58. The above described components enable the electronic device 28 to send/receive various messages to/from other devices that may reside on a network in accordance with the various embodiments of the present invention. Individual circuits and elements are all of a type well known in the art, for example in the Nokia range of mobile telephones.

Various embodiments described herein are described in the general context of method steps or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Embodiments of the present invention may be implemented in software, hardware, application logic or a combination of software, hardware and application logic. The software, application logic and/or hardware may reside, for example, on a chipset, a mobile device, a desktop, a laptop or a server. Software and web implementations of various embodiments can be accomplished with standard programming techniques with rule-based logic and other logic to accomplish various database searching steps or processes, correlation steps or processes, comparison steps or processes and decision steps or processes. Various embodiments may also be fully or partially implemented within network elements or modules. It should be noted that the words “component” and “module,” as used herein and in the following claims, is intended to encompass implementations using one or more lines of software code, and/or hardware implementations, and/or equipment for receiving manual inputs.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

What is claimed is:

1. A method, comprising:
receiving an indication of list of contacts in an address book to receive an automatic update;
submitting a subscription request for the contacts;
receiving updates for contact information for the subscribed contacts; and
synchronizing the updates with the address book, wherein the synchronizing includes synchronizing only the updated contacts.

2. The method of claim 1, wherein the receiving an indication includes receiving a filtering document.

3. The method of claim 1, wherein the receiving an indication includes receiving a list of contact entries.

4. The method of claim 3, wherein the list of contact entries is in the form of an XML document.

5. The method of claim 1, wherein the submitting a subscription request includes using a session initiation protocol subscription mechanism.

6. An apparatus, comprising:
a processor; and
a memory unit communicatively connected to the processor and including:
computer code for receiving an indication of list of contacts in an address book to receive an automatic update;
computer code for submitting a subscription request for the contacts;
computer code for receiving updates for contact information for the subscribed contacts; and
computer code for synchronizing the updates with the address book, wherein the synchronizing includes synchronizing only the updated contacts.

7. The apparatus of claim 6, wherein the computer code for receiving an indication includes computer code for receiving a filtering document.

8. The apparatus of claim 6, wherein the computer code for receiving an indication includes computer code for receiving a list of contact entries.

9. The apparatus of claim 8, wherein the list of contact entries is in the form of an XML document.

10. The apparatus of claim 6, wherein the computer code for submitting a subscription request includes computer code for using a session initiation protocol subscription mechanism.

11. A computer program product, embodied on a computer-readable medium, comprising:
computer code for receiving an indication of list of contacts in an address book to receive an automatic update;
computer code for submitting a subscription request for the contacts;
computer code for receiving updates for contact information for the subscribed contacts; and
computer code for synchronizing the updates with the address book, wherein the synchronizing includes synchronizing only the updated contacts.

12. The computer program product of claim 11, wherein the computer code for receiving an indication includes computer code for receiving a filtering document.

13. The computer program product of claim 11, wherein the computer code for receiving an indication includes computer code for receiving a list of contact entries.

14. The computer program product of claim 13, wherein the list of contact entries is in the form of an XML document.

15. The computer program product of claim 11, wherein the computer code for submitting a subscription request includes computer code for using a session initiation protocol subscription mechanism.
